(19) United States
(12) Patent Application Publication
(10) Pub. No.: US 2007/0127261 A1
(43) Pub. Date: Jun. 7, 2007

(54) LED backlight device

(75) Inventors: In Geol An, Gwangmyung (KR); Jong Jin Park, Daejeon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/593,014

(22) Filed: Nov. 6, 2006

(30) Foreign Application Priority Data
Dec. 2, 2005 (KR) 10-2005-0117160

(51) Int. Cl. F21V 7/04

(52) U.S. Cl. 362/608; 362/612

(57) ABSTRACT

An LED backlight device is provided. A light guide plate has opposing edges of a width direction at a side thereof extended into a pair of opposing walls and a recess formed therebetween. A light emitting diode (LED) light source is accommodated in the recess to project light into the light guide plate. In this fashion, the light guide plate has the recess formed at one side of the light guide plate to seat the LED package therein. This minimizes loss of light incident from the LED package into the light guide plate and allows the LED package to be aligned securely with the light guide plate.

### CLAIM OF PRIORITY

This application claims the benefit of Korean Patent Application No. 2005-117160 filed on Dec. 2, 2005 in the Korean Intellectual Property Office, the disclosure of which is incorporated herein by reference.

### BACKGROUND OF THE INVENTION

1. Field of the Invention

The present invention relates to a backlight device, more particularly a light emitting diode (LED) backlight device in which a recess is formed at one side of a light guide plate to seat an LED package therein, thereby minimizing loss of light incident from the LED package into the light guide plate and allows the LED package to be aligned securely with the light guide plate.

2. Description of the Related Art

Liquid crystal displays (LCDs) require external light due to absence of its own light source and typically adopt a backlight device for lighting. The backlight device illuminates an LCD from behind and uses a Cold Cathode Fluorescent Lamp (CCFL) or LEDs as a light source.

FIG. 1 illustrates an LED backlight device which uses LEDs as a light source.

The LED backlight device 10 includes LED packages 20 (only one is shown) and a light guide plate 20. Of course, although not illustrated, as known in the art, the LED backlight device 10 may further include a housing and a light scattering pattern and a reflecting plate on an underside surface 36 of the light guide plate 20.

The LED package 20 includes an LED chip 22, a pair of lead frames 24 for supporting the LED chip 22 and supplying a power voltage and a package body 26. The package body 26 has an LED window, i.e., a transparent portion formed therein to emit light generated from the LED chip 22 forward in the direction of the light guide plate 30.

Light L radiated from the-LED package 20 to the light guide plate 30 enters the light guide plate 30 through a side 32 in a front part 30a of the light guide plate 30, and propagates toward a rear part 30b. Subsequently, the light is internally reflected on a top surface 34 and the underside surface 36 of the light guide plate 30 and propagates around in the light guide plate 30. Then the light is emitted upward through the top surface 34 of the light guide plate 30 by the light scattering pattern and reflecting plate. The light emitted becomes incident into a liquid panel of an LCD via a light diffusion plate and a prism sheet (not illustrated) disposed in an upper part of the light guide plate 30 to thereby provide backlight lighting.

As shown in FIG. 1, for convenience's sake, light L is shown coming from one point F of the-LED chip 22.

Meanwhile some portion L1 of light emitted from the LED package 20 to the light guide plate 30 is reflected without entering edges of the side 32 of the light guide plate 30, thus causing light loss. Of course, the LED package 20, when attached to the light guide plate 30, can diminish light loss as just described.

But generally RGB LEDs are combined together to produce white light. Thus a certain distance is required to mix light beams emanated from the RGB LEDs together to obtain white light. That is, even if the light guide plate 30 is elongated by distance d of FIG. 1 to contact the LED package 20, the distance d does not serve as a lighting area of the liquid panel but only belongs to a Bezel width in the LCD. Therefore, the LED package attached to the light guide plate still fails to decrease an entire Bezel width. Moreover, such an unnecessary increase in the light guide plate disadvantageously adds weight to the overall LED backlight device.

Also, as shown in FIG. 1, the LED package 20, when disposed at a side of the light guide plate 30, is problematic due to following reasons. The LED package 20 disposed in an outer periphery of the light guide plate 30 may interfere with other parts during assembling of the backlight device 10. Thus, the LED package 20 is hard to align precisely with the light guide plate 30. Furthermore, the LED package, when fixed to the housing, is directly affected by any external impact which may be applied to the housing.

### SUMMARY OF THE INVENTION

The present invention has been made to solve the foregoing problems of the prior art and it is therefore an object according to certain embodiments of the present invention is to provide an LED back light device for a Liquid Crystal Display (LCD) in which a recess is formed at a side of a light guide plate to accommodate the LED package, thereby minimizing loss of light incident from the LED package into a light guide plate and aligning the LED package with the light guide plate securely.

Another object according to certain embodiments of the invention is to provide an LED backlight device for an LCD in which a rough pattern is formed on a wall of the recess to increase an angle of incidence of light that is incident from the LED package into the light guide plate, thereby reducing a distance necessary for color combination to obtain white light.

According to an aspect of the invention for realizing the object, there is provided a backlight device including a light guide plate having opposing edges of a width direction at a side thereof extended into a pair of opposing walls and a recess formed therebetween; and a light emitting diode (LED) light source is accommodated in the recess to project light into the light guide plate.

The backlight device further includes a plate member having both edges joined to respective distal ends of the walls of the light guide plate, the LED light source attached to a surface of the plate member facing the recess of the light guide plate. Preferably, the plate member comprises a metal substrate.

According to the invention, the LED light source may be fitted into the recess.

An outer surface of the recess of the light guide plate has a rough pattern formed thereon so that light radiated from the LED package is diffused into the light guide plate. Here, the rough pattern comprises one selected from a group consisting of a prism, an embossed semi-cylinder, a depressed semi-cylinder and mixtures thereof.

Also, each of the walls has a curved base connected to the light guide plate, the curved bases of the walls opposing each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating a conventional LED backlight device;

FIG. 2 is a perspective view illustrating an LED backlight device according to the invention;

FIG. 3 is a front elevation view of FIG. 2.

FIG. 4 is a cross-sectional view cut along the line 4-4 of FIG. 3;

FIG. 5 is a cross-sectional view illustrating the light guide plate with an LED package attached thereto via a support plate;

FIG. 6 is a perspective view illustrating an LED backlight device according to another embodiment of the invention, in which LED packages are not shown;

FIG. 7 is a cross-sectional view cut along the line 7-7 of FIG. 6;

FIG. 8 is a cross-sectional view cut along the line 8-8 of FIG. 6;

FIG. 9 is a perspective view illustrating an LED backlight device according to further another embodiment of the invention, in which LED packages are not shown; and

FIG. 10 is a cross-sectional view cut along the line 10-10 of FIG. 9.

### DETAILED DESCRIPTION OF THE PREFERRED EMBODIMENT

Preferred embodiments of the present invention will now be described in detail with reference to the accompanying drawings.

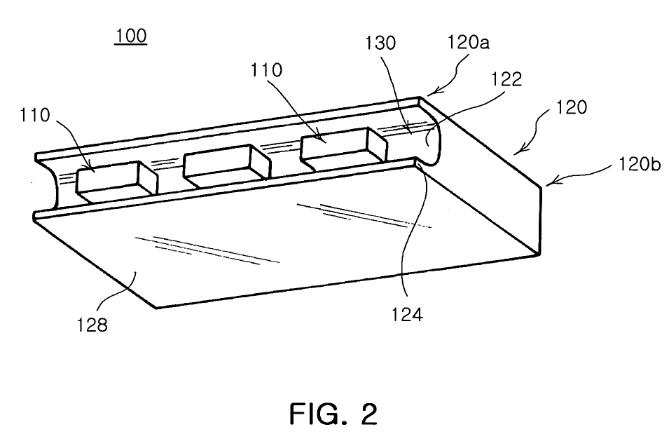

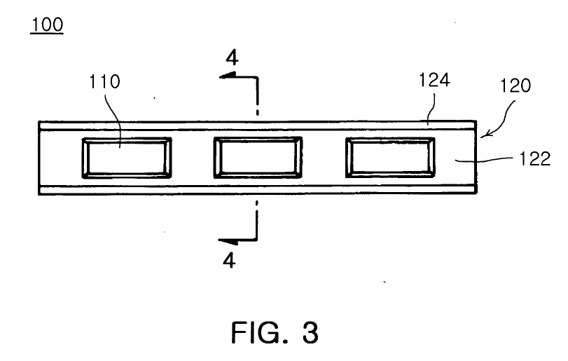

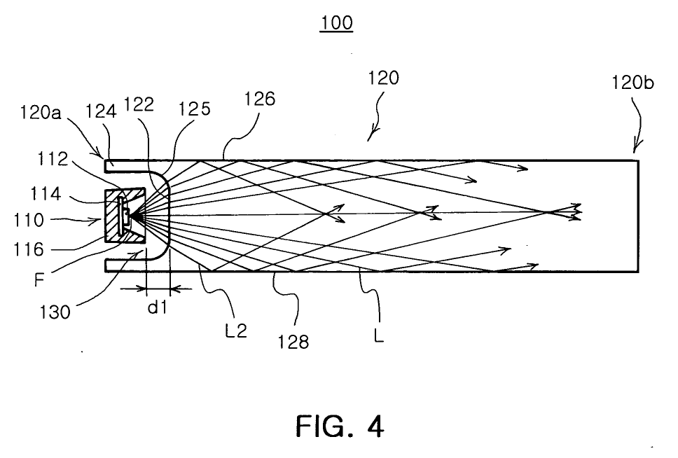

FIG. 2 is a perspective view illustrating an LED backlight device of the invention. FIG. 3 is a-front elevation view of FIG. 2 and FIG. 4 is a cross-sectional view cut along the line 4-4 of FIG. 3.

Referring to FIGS. 2 to 4, the LED backlight device 100 of the invention includes a light guide plate 120 and three LED packages 110. The light guide plate 120 has a recess 130 formed at one side thereof along a width direction except for edges. The three LED packages 110 accommodated in the recess function as a light source. Here, the three LED packages 110 are illustrated as exemplary and the number of the LED packages 110 may be varied if necessary.

Also, although not illustrated but as known in the art, the LED backlight device 100 of the invention further includes a housing, and a light scattering pattern and a reflecting plate disposed on an underside surface 128 of the light guide plate 120.

Now a detailed explanation will be given about each component of the LED backlight device 100.

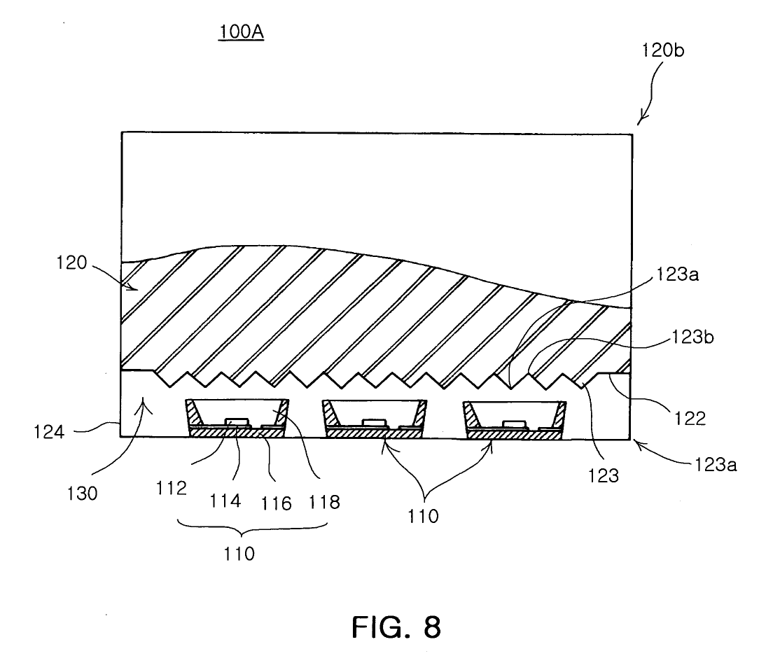

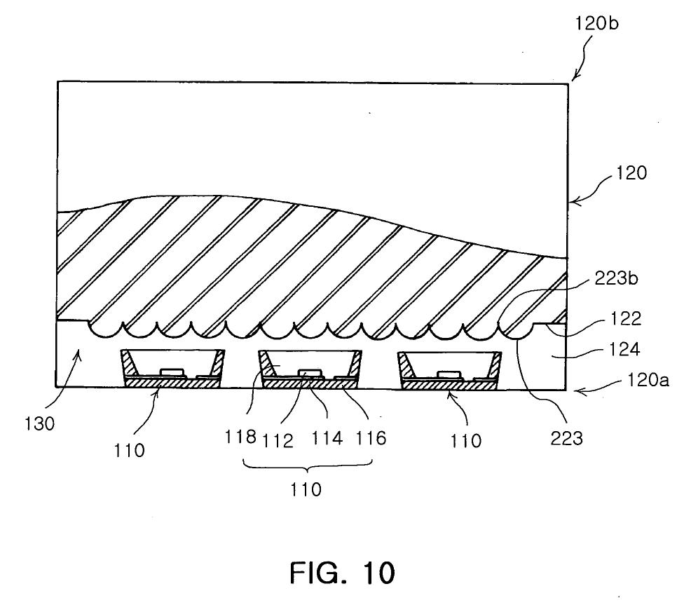

First, the LED package 110 includes an LED chip 112, a pair lead frames 114 for supporting the LED chip 112 and supplying a power voltage and a package body 116 surrounding the LED chip 112 and the lead frames 114. The package body 116 includes a transparent portion, i.e., an LED window (see the reference sign 118 of FIGS. 8 and 10) for emitting light generated from the LED chip 112 forward in the direction of the light guide plate.

The light guide plate 120 is a plate member having a predetermined thickness, and made of one selected from a group consisting of a transparent acryl, polymethylmethacrylate (PMMA), plastic and glass. The light guide plate 120 has a recess 130 formed in a front part 120a thereof to accommodate the LED package. Meanwhile the light guide plate 120 has a uniform planar surface in a rear part thereof. Here, the front part 120a of the light guide plate 120 indicates a side in the vicinity of the LED package 110 and the rear part 120b indicates a side opposite thereto.

Moreover, the recess 130 is formed in an area excluding the edges of the Light guide plate 120, thereby leaving walls 124 opposing each other in upper and lower parts along a width direction. The LED package 110 is accommodated in the recess 130 and an inner surface of the walls 124 is connected to a side 122 of the light guide plate 120 via a curved connecting part 125. To form this recess 130, the side of the original light guide plate is carved out or a mold with a desired shape of the light guide plate is used.

With the LED package 110 disposed inside the recess 130 as just described, the walls 124 protect the LED package 110 from external impact.

Meanwhile, in the drawings, a thickness of the LED package 110 is smaller than that of the recess 130. Optionally, the recess 130 may be as wide as the LED package fitted thereinto. This assures the LED package 110 to be aligned with the light guide plate 120 more easily. Here, the LED package 110 may be placed at a predetermined distance d1 from the side of the light guide plate 120. Alternatively, the LED package 110 may be fitted to the side 122 of the light guide plate.

Next, operation of the LED backlight device 100 will be explained with reference to FIG. 4. Here, for convenience's sake, light L is shown coming from one point F of the LED chip 112.

With the LED chip 112 emitting light, light L radiated from the LED package 110 to the light guide plate 120 enters the light guide plate 120 through the side 122 of the front part 120a thereof. Then light is internally reflected on the top and underside surfaces 126 and 128 of the light guide plate 120 and propagates around inside the light guide plate 120. Thereafter, the light is emitted upward through the top surface 126 via the light scattering pattern and reflecting plate (not illustrated). The light emitted typically enters a liquid panel of an LCD through a light diffusion plate and a prism sheet (not illustrated) disposed in an upper part of the light guide plate 120, thereby backlighting the LCD.

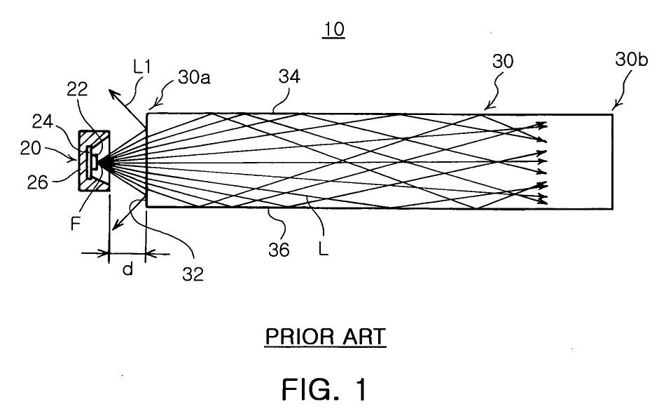

Here, some portion of light L2 corresponds to some portion of light L1 shown in FIG. 1. However, since unlike FIG. 1, the light is incident into the light guide plate, the LED backlight device 100 of the invention exhibits higher optical efficiency than the prior art.

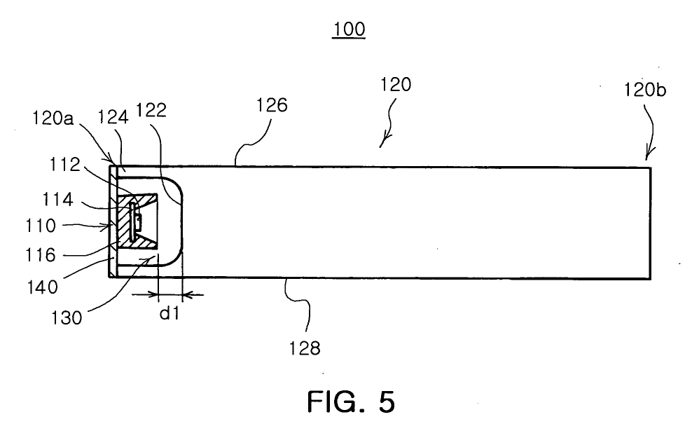

FIG. 5 illustrates an example of an LED package 110 mounted.

As shown in FIG. 5, the LED package 110 is fixed to a support plate 140 when accommodated inside a recess 130. The support plate 140 is joined to respective distal ends of the walls 124 by appropriate means such as an adhesive.

This allows the LED package 110 to be aligned with the light guide plate 120 more precisely and more easily. That is, the LED package 110 can be aligned with the light guide plate 120 more effectively only by positioning the LED package 110 precisely on the support plate 140.

Preferably, the support plate 140 is comprised of a metal substrate which ensures heat generated from the LED chip 112 to be released outward easily.

Here, the LED package 110 can be aligned with the light guide plate by virtue of other structures in place of such a support plate 140. For example, as described above, the LED package 110 and the recess 130 formed to fit with each other, enable the LED package 110 to be aligned with the light guide plate 120 easily even without the support plate 140.

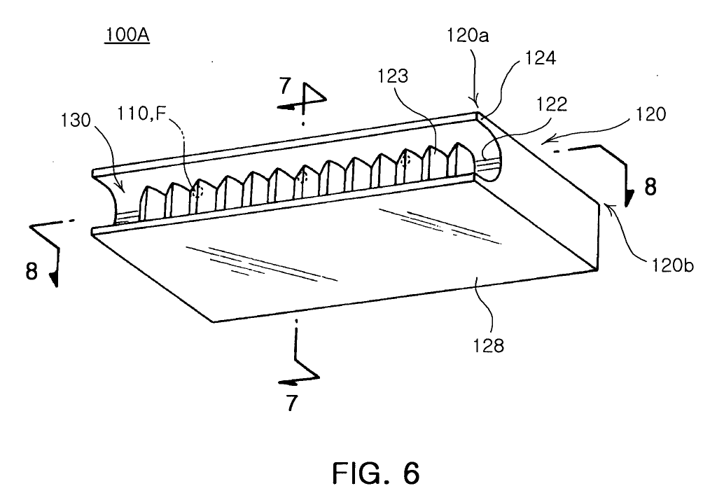

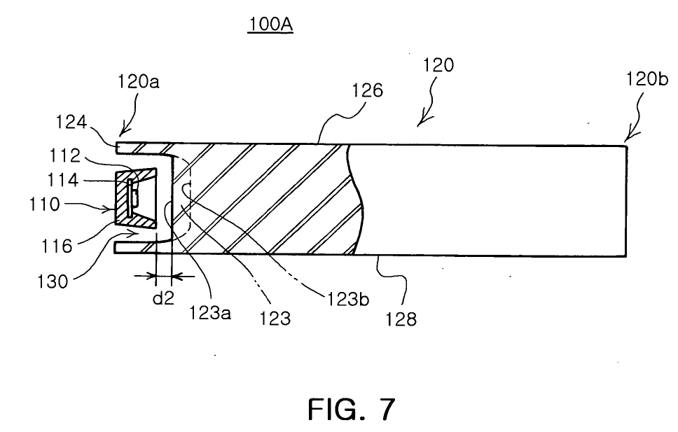

FIG. 6 is a perspective view illustrating an LED backlight device according to another embodiment of the invention, in which LED packages are not shown. FIG. 7 is a cross-sectional view cut along the line 7-7 of FIG. 6 and FIG. 8 is a cross-sectional view cut along the line 8-8 of FIG. 6.

The LED backlight device 100A of the FIGS. 6 and 7 is identical to the LED backlight device 100 as just described except that prisms 123 are protruded from a side 122 of a light guide plate 120 inside a recess 130 in this embodiment. Therefore like components are denoted by like numerals and will be explained in no more detail.

Each of the prisms 123 has a ridge 123a protruded at a predetermined height and a furrow 123b. Adjacent ones of the prisms 123 are connected with each other by the furrows. In this structure, light incident from the LED package 110 into the light guide plate 120 can be diffused as in FIG. 8. As a result, monochromatic light incident from each single color LED package of R, G and B into the light guide plate 120 is mixed together, thereby shortening a distance for producing white light. This further diminishes a distance d2 between the LED package 110 and the light guide plate 120, thereby miniaturizing an overall backlight device 10A.

In addition, the backlight device 100 of this invention, may adopt a support plate 140 as shown in FIG. 5 to align the LED package 11 with the light guide plate 120.

Meanwhile, the ridge 123a and/or the flat furrow 123b of the each prism 123 may be flattened at ends. Such a flat portion may be minimally sized to thereby form the prisms 123 easily and ensure light diffusing effect as well.

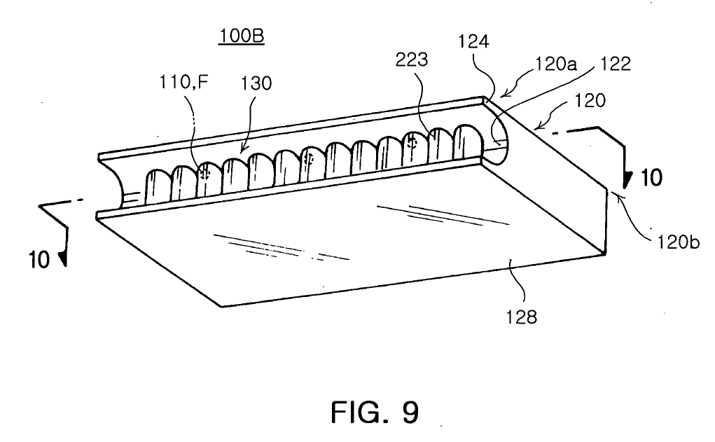

FIG. 9 is a perspective view illustrating an LED backlight device according to further another embodiment of the invention, in which LED packages are not shown. FIG. 10 is a cross-sectional view cut along the line 10-10 of FIG. 9.

Referring to FIGS. 9 and 10, the LED backlight device 100B of this embodiment is identical to the LED backlight device 100 according to the aforesaid embodiment except that semi-cylinders 223 are protruded from a side 122 of a light guide plate 120 inside a recess 130 in this embodiment. Therefore, like components are denoted by like numerals and will be explained in no more detail.

Each of the semi-cylinders 223 is protruded at a predetermined height and connected to an adjacent semi-cylinder by a furrow 223b. This structure assures light incident from the LED package 110 into the light guide plate 120 to be diffused more as shown in FIG. 10. As a result, monochromatic light incident from each single color LED package of R, G and B into the light guide plate 120 is mixed together, thereby shortening a distance for producing white light. This further diminishes a distance between the LED package 110 and the light guide plate 120 (see d2 of FIG. 7), thereby miniaturizing an overall backlight device 100B.

Also, the backlight device 100B of this invention may employ a support plate 140 as shown in FIG. 5 to align the LED package 110 with the light guide plate 120.

Meanwhile, the furrow 123b of the each semi-cylinder 223 may be flattened at an end. Here, such a flat portion may be minimally sized to thereby form the semi-cylinders 223 more easily and ensure light diffusing effect as well.

Moreover, in place of the semi-cylinders 223, depressed semi-cylinders may be formed on the side 122 of the light guide plate. Also, the semi-cylinders 223 may be variously modified e.g., in combination of the prisms 123 as just described.

As set forth above, according to preferred embodiments of the invention, a recess is formed at a side of a light guide plate to seat an LED package therein. This minimizes loss of light incident from the LED package to the light guide plate and aligns the LED package securely with the light guide plate. Also, a rough pattern such as a prism or a semi-cylinder may be formed on a wall of the recess to increase an angle of incidence of light that is incident from the LED package into the light guide plate, thereby reducing a distance necessary for color combination to obtain white light. In addition, the LED package may be fixed to a support plate, which is then joined to the recess of the light guide plate. This enables the LED package to be aligned with the light guide plate more easily.

While the present invention has been shown and described in connection with the preferred embodiments, it will be apparent to those skilled in the art that modifications and variations can be made without departing from the spirit and scope of the invention as defined by the appended claims.

What is claimed is:

1. A backlight device comprising:
a light guide plate having opposing edges of a width direction at a side thereof extended into a pair of opposing walls and a recess formed therebetween; and
a light emitting diode (LED) light source accommodated in the recess to project light into the light guide plate.

2. The backlight device according to claim 1, further comprising: a plate member having both edges joined to respective distal ends of the walls of the light guide plate, the LED light source attached to a surface of the plate member facing the recess of the light guide plate.

3. The backlight device according to claim 2, wherein the plate member comprises a metal substrate.

4. The backlight device according to claim 1, wherein the LED light source is fitted into the recess.

5. The backlight device according to claim 1, wherein an outer surface of the recess of the light guide plate has a rough pattern formed thereon so that light radiated from the LED package is diffused into the light guide plate.

6. The backlight device according to claim 5, wherein the rough pattern comprises one selected from a group consisting of a prism, an embossed semi-cylinder, a depressed semi-cylinder and mixtures thereof.

7. The backlight device according to claim 1, wherein each of the walls has a curved base connected to the light guideplate, the curved bases of the walls opposing each other.
